(19) United States
(12) Patent Application Publication
(10) Pub. No.: US 2010/0090137 A1
(43) Pub. Date: Apr. 15, 2010

(54) FLOW RATE CONTROL DEVICE

(75) Inventor: Takashi Kato, Aichi (JP)

Correspondence Address: Beyer Law Group LLP, P.O. BOX 1687, Cupertino, CA, 95015-1687, US

(73) Assignee: CKD CORPORATION, Aichi (JP)

(21) Appl. No.: 12/561,120

(22) Filed: Sep. 16, 2009

(30) Foreign Application Priority Data
Oct. 10, 2008 (JP) 2008-263908

(51) Int. Cl. F16K 31/00; F16K 15/00

(52) U.S. Cl. 251/61.1; 137/511

(57) ABSTRACT

The flow rate control device is equipped with a pilot regulator that applies operating pressure by using air supplied to one surface of a diaphragm provided in the regulator and adjusts the flow rate of a chemical liquid contacting the opposite surface, and with an electropneumatic regulator that controls supply and discharge of air to adjust the operating pressure for the pilot regulator. The flow rate control device is equipped with an air passage that connects and passes air between the pilot regulator and electropneumatic regulator, and an orifice that enables adjustment of operating pressure by the electropneumatic regulator while discharging air from the air passage.

The present application claims priority based on Japan Patent Application No. 2008-263908 filed on Oct. 10, 2008, and the entire contents of that application is incorporated by reference in this specification.

### FIELD OF THE INVENTION

The present invention relates to a flow rate control device for controlling the flow rate of a fluid.

### BACKGROUND OF THE INVENTION

A flow rate control valve to control the flow rate of liquids, gases, and other fluids has been known. In this flow rate control valve, when a mechanism for driving valve bodies exists inside the valve, gas constituents derived from the fluid (the controlled object) can seep through the diaphragm inside the valve and remain around the drive mechanism. In this case, depending on the properties of these gas constituents, there is a risk of corrosion to the component parts of the drive mechanism. In order to solve the problem, there are flow rate control valves for suppressing corrosion of valve-body-drive mechanisms by these gas constituents (for example, see Patent Document 1). In addition, there are flow rate control valves driven by electromagnetic actuators, for suppressing corrosion of the actuators, wiring or the like by the gas constituents (for example, see Patent Document 2).

Meanwhile, there are flow rate control valves that applies operation pressure by using gas supplied to one surface of a diaphragms and adjusts the flow rate of a fluid contacting the opposite surface (for example, see Patent Document 3). As shown in FIG. 6, in the flow rate control valve 301, air flows in and out through the air intake port 351, and the operating pressure generated by this air drives the valve body 312 linked to the diaphragm 311. As a result, there is no mechanism for driving valve body 312 such as a piston or electromagnetic actuator in the air space 341 which is on one side of the space separated by diaphragm 311 and on the side opposite to the valve body 312, and therefore no corrosion of a drive mechanism due to gas constituents seeping through the diaphragm 311.

[Patent Document 1] Japan Published Patent Application No. 2004-19792

[Patent Document 2] Japan Published Patent Application No. 2003-83468

[Patent Document 3] Japan Published Patent Application No. 2008-202654

### SUMMARY OF THE INVENTION

In the flow rate control valve in the Patent Document 3, a regulator to adjust the operating pressure by using control of the supply and discharge of air for the air intake port 351 is needed, and air containing the gas constituents passes through this regulator. As a result, a situation where corrosion of component parts in the regulator adjusting the operating pressure, due to gas constituents passing through the diaphragm 311, becomes a new concern.

A primary object of the preset invention is to provide a flow rate control device that can use control of the supply and discharge of gases for the flow rate control valve to suppress corrosion in the regulator adjusting the operating pressure of the flow rate control valve.

To resolve the above problem, a first aspect of the invention comprises a first regulator that applies operating pressure by using gas supplied to one surface of a diaphragm provided in the regulator, thereby adjusting the flow rate of a fluid contacting the opposite surface, a second regulator that controls supply and discharge of the gas for the first regulator, to adjust the operating pressure, a gas passage that passes the gas between the first regulator and second regulator, and a restriction passage that enables adjustment of the operating pressure by the second regulator while discharging the gas from the restriction passage. In addition, a second aspect of the invention comprises a first regulator that applies operating pressure by using gas supplied to one surface of a diaphragm provided in the regulator, thereby adjusting the flow rate of a fluid contacting the opposite surface, a second regulator that controls supply and discharge of the gas for the first regulator, to adjust the operating pressure, a gas passage that passes the gas between the first regulator and second regulator, and a restriction passage connected to the gas passage with a predetermined microscopic flow passage area.

Because the first and second aspects of the inventions comprise a first regulator that applies operating pressure by using gas supplied to one surface of a diaphragm provided in the regulator, thereby adjusting the flow rate of a fluid contacting the opposite surface, and a second regulator that controls supply and discharge of the gas for the first regulator, to adjust the operating pressure, the flow rate of a fluid can be adjusted by the first regulator, based on the operating pressure adjusted by the second regulator.

Here, because the fluid targeted for adjustment of flow rate contacts the diaphragm of the first regulator, gas constituents derived from the fluid can seep through the diaphragm. Moreover, gas constituents can traverse the gas passage that passes gases for adjustment of the operating pressure between the first regulator and second regulator, to pass through the second regulator, and threaten a corrosive situation in the second regulator component parts.

On this point, because the first aspect of the invention comprises a restriction passage that enables adjustment of the operating pressure by the second regulator while discharging the gas from the restriction passage, and the second aspect of the invention comprises a restriction passage connected to the gas passage with a predetermined microscopic flow passage area, they can, while using the second regulator to enable adjustment of the operating pressure, discharge the gas constituents from the restriction passage to reduce the amount of gas constituents passing through the second regulator. In addition, when the gases containing the gas constituents exist in the gas passage in a relatively high-pressure state, the gas can be discharged from the restriction passage even if the second regulator has been closed and shut down, to reduce the amount of gas constituents contacting the second regulator. As a result, corrosion of the second regulator adjusting the operating pressure of the first regulator can be suppressed. Note that the restriction passage can be formed by processing the gas passage that passes the gas between the first regulator and second regulator, or formed to a passage branched from the gas passage. In addition, this gas passage is not limited to piping connecting the first regulator and second regulator, but also includes internal passages for passing gases internally within the regulators.

Furthermore, if a variable-type restriction passage capable of changing the flow passage area is used as the restriction passage, the flow passage area can be adjusted after the restriction passage has been assembled, thus the second regulator can adjust the operating pressure while the restriction passage is set to the optimum flow passage area for discharging the gases from the gas passage.

In either the first or second aspects of the invention, a third aspect of the invention comprises a check valve in the gas passage, between the second regulator and the restriction passage, to force the gas to flow only in the direction from the second regulator to the first regulator. In the third aspect, the gas can be forced to flow in the direction from the second regulator to the first regulator when increasing the operating pressure, and the gas can be discharged from the restriction passage when decreasing the operating pressure. Consequently, only gas that does not contain the gas constituents is allowed to pass through the second regulator, while gas containing the gas constituents cannot pass through the second regulator, to further suppress corrosion in the second regulator.

Furthermore, forming the check valve with materials having anticorrosive properties versus fluids targeted for adjustment of flow rate, or gas constituents derived from the fluids can suppress instability in operations due to corrosion in the check valve used to prevent passage of gases containing gas constituents in the direction of the second regulator. Note that the check valve component parts and materials can be formed of anticorrosive materials, or the surfaces of the check valve component parts and materials can be sheathed with anticorrosive materials.

In addition, when a check valve is installed in the gas passage between the second regulator and the restriction passage, discharging gas from the restriction passage can be used to lower the operating pressure, but there is a risk of reduced responsiveness when the operating pressure is lowered.

On this point, a forth aspect of the invention involves installation in the third aspect of the invention of the restriction passage and the check valve in positions closer to the first regulator than to the second regulator, thus the volume of gases discharged when the operating pressure is lowered can be reduced. As a result, when a check valve is installed, the drop in responsiveness when the operating pressure is lowered can be suppressed.

Furthermore, a fifth aspect of the invention involves installation in the forth aspect of the invention of the restriction passage at the first regulator, thus the volume of gases discharged when the operating pressure is lowered can be sharply reduced, and manufacture can be eased through installation of the restriction passage on, for example, the first regulator cover or body.

The above and other objects, features, and advantages of the present invention will be apparent from the following description when taken in conjunction with the accompanying drawings which illustrate preferred embodiments of the present invention by way of example.

### BRIEF DESCRIPTION OF DRAWINGS

FIG. 1 Circuit diagram showing overall configuration of chemical liquid supply circuit equipped with flow rate control device in one embodiment.

FIG. 2 Vertical cross-sectional view showing configuration of pilot regulator in one embodiment.

FIG. 3 Circuit diagram showing schematic view of electropneumatic regulator in one embodiment.

FIG. 4 Circuit diagram showing configuration of flow rate control device in another embodiment.

FIG. 5 Vertical cross-sectional view showing configuration of pilot regulator in another embodiment.

FIG. 6 Vertical cross-sectional view showing configuration of conventional pilot regulator.

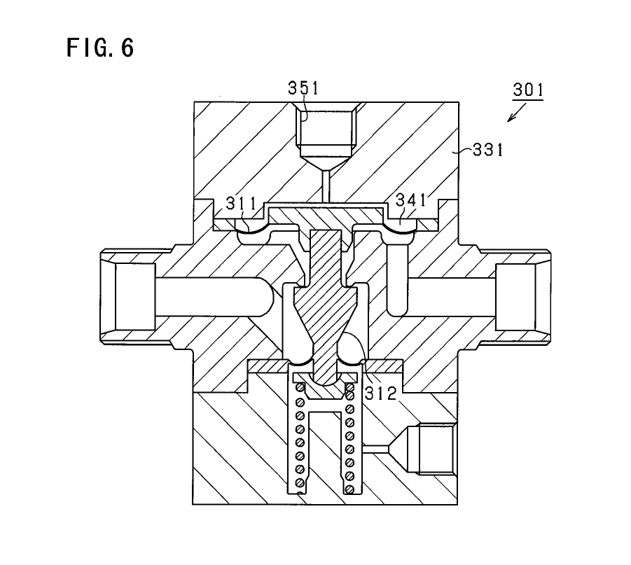

### DESCRIPTION OF THE PREFERRED EMBODIMENTS

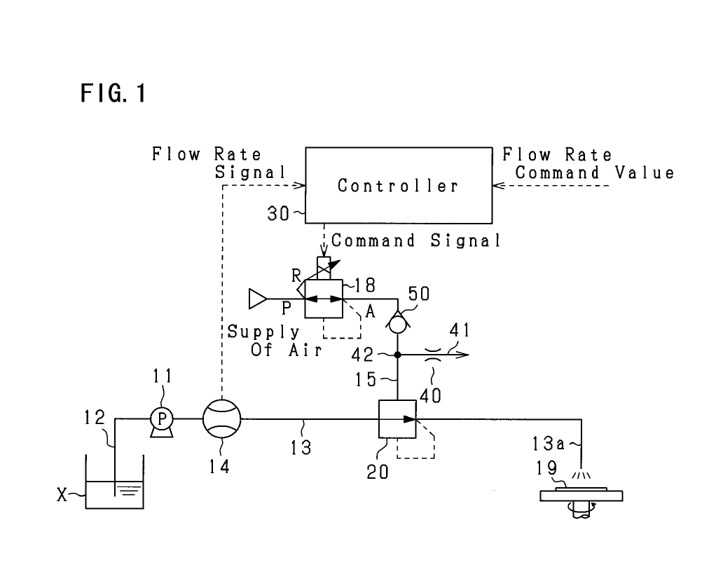

The specific formation of one embodiment of a flow rate control device used in the supply of chemical liquid on a semiconductor manufacturing line will be explained below with reference to drawings. Note that FIG. 1 is a circuit diagram showing the overall configuration of a chemical liquid supply circuit equipped with a flow rate control device.

As shown in FIG. 1, in this circuit a chemical liquid pump 11 is installed for suction and discharge of the chemical liquid. The chemical liquid pump 11 consists of, for example, a diaphragm pump or bellows pump. Chemical liquid held in a chemical liquid tank X is sucked in by the chemical liquid pump 11, through a suction pipe 12 that composes of a chemical liquid suction passage.

The discharge side of the chemical liquid pump 11 is connected to a discharge pipe 13 that composes of a chemical liquid discharge passage. On the downstream side of the discharge pipe 13, a pilot regulator 20 functioning as the first regulator is installed. Chemical liquid discharged from the chemical liquid pump 11 is controlled to the predetermined flow rate by the pilot regulator 20 and discharged to a wafer 19. Note that the tip on the downstream side of the discharge pipe 13 is a discharge nozzle 13a for discharging chemical liquid to the wafer 19.

The pilot regulator 20 uses air supplied from an electropneumatic regulator 18 functioning as the second regulator to apply operating pressure, and controls the flow rate of the chemical liquid based on this operating pressure. The electropneumatic regulator 18 uses control of the supply and discharge of air to the pilot regulator 20 to adjust operating pressure for the pilot regulator 20. This pilot regulator 20 and electropneumatic regulator 18 are connected by an air passage 15, and air for adjustment of the operating pressure is passed through this air passage 15. Note that the air passage 15 is a part of the gas passage that passes gases between the first regulator and second regulator.

In addition, a flow rate sensor 14 for detecting the chemical liquid flow rate is equipped in the discharge pipe 13 between the chemical liquid pump 11 and pilot regulator 20.

A controller 30 is an electronic control device composed mainly of a microcomputer consisting of a CPU, various kinds of memory or the like. The controller 30 receives input of flow rate command values from a control computer managing and controlling the system, and sequentially receives input of fluid flow rate detected by a flow rate sensor 14. Based on these inputs, the controller 30 drives the electropneumatic regulator 18, and implements flow rate feedback control to ensure that the fluid flow rate matches the flow rate command values.

The controller 30 calculates the deviation between the flow rate command value input from the control computer and the fluid flow rate detected by the flow rate sensor 14, and performs a PID calculation or other calculation process based on that deviation to output a command signal for the electropneumatic regulator 18. Then, based on command signals from the controller 30, the electropneumatic regulator 18 uses control of supply and discharge of air to adjust the operating pressure for the pilot regulator 20. Repeated execution of this process enables the fluid flow rate to converge toward the command value.

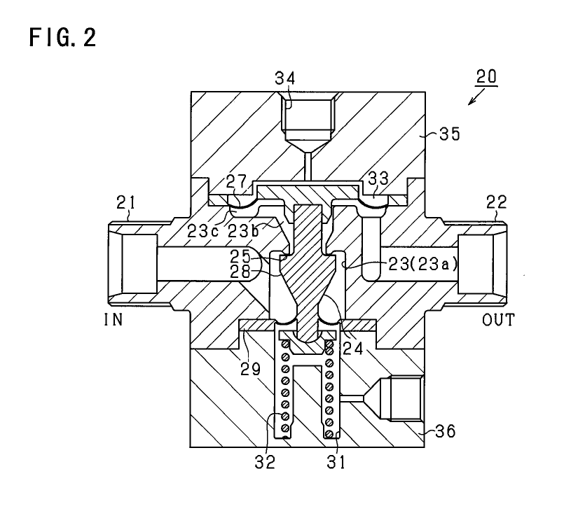

Next, the pilot regulator configuration will be explained based on FIG. 2. Note that FIG. 2 is a cross-sectional view showing configuration of the pilot regulator.

The pilot regulator 20 is equipped with a first cover 35 and a second cover 36, and an intake part 21 for intake of fluid and a discharge part 22 for discharging the fluid are assembled between the covers 35 and 36. Note that the intake part 21 and discharge part 22 contacting the chemical liquid are formed, for example, from a fluorinated synthetic resin to make them resistant to corrosion, while the covers 35 and 36 that do not contact the chemical liquid are formed, for example, from polypropylene resin.

Roughly in the center of the pilot regulator 20, a through hole, functioning as a valve chamber 23 connected to the intake part 21 and discharge part 22, is formed to extend in the direction of assembly of the first cover 35 and second cover 36. In the valve chamber 23, the hole diameter becomes smaller midway through the assembly direction. In other words, the inner wall surface of the valve chamber 23 protrudes inward midway along, and this protruding section forms a valve seat 25. In addition, the valve chamber 23 consists of an upstream valve chamber 23a upstream from the valve seat 25 and a downstream valve chamber 23b downstream from the valve seat 25. Moreover, even further downstream from the downstream valve chamber 23b there is a circular passage 23c formed where the hole diameter widens, and this circular passage 23c communicates with the discharge part 22.

The valve chamber 23 houses a cylindrical shaped valve body 24 that can perform reciprocal motion in the direction of assembly of the first cover 35 and second cover 36. The valve body 24 is connected to two diaphragms 27 and 29, with the valve body 24 and one diaphragm 29 formed as a single unit. Note that the valve body 24, and both diaphragms 27 and 29 in contact with the chemical liquid are formed, for example, from a fluorinated synthetic resin to make them resistant to corrosion.

In the valve body 24, a wide diameter part 28 that is larger in diameter than other parts is formed midway along the axial line direction. The end of the wide diameter part 28 opposing the valve seat 25 is formed with a larger inner diameter than the valve seat 25, and is designed so that it can contact the valve seat 25. Therefore, when the valve body 24 moves in the direction toward one diaphragm 27, the end of the wide diameter part 28 comes in contact with the valve seat 25 and the communication between the intake part 21 and discharge part 22 is shut off. On the other hand, if the valve body 24 moves in the direction toward the other diaphragm 29, the end of the wide diameter part 28 separates from the valve seat 25, and the intake part 21 and discharge part 22 communicate with each other.

A spring housing chamber 31 is formed in the second cover 36 on one side of the space separated by the diaphragm 29 and on the side opposite to the valve chamber 23. The spring housing chamber 31 houses a compression coil spring 32. Urging force of this compression coil spring 32 keeps the valve body 24 constantly urged toward the diaphragm 27 side. This arrangement maintains the end of the wide diameter part 28 formed at the valve body 24 in a state of contact with the valve seat 25.

A pressure operation chamber 33 is formed for intake of air from the outside of the pilot regulator 20 on one side of the space separated by the diaphragm 27 and on the side opposite to the valve chamber 23. The pressure operation chamber 33 communicates with an air intake port 34 formed in the first cover 35. The air intake port 34 is supplied air from the electropneumatic regulator 18 through the air passage 15 (see FIG. 1). The electropneumatic regulator 18 uses control of supply and discharge of air to adjust the operating pressure for the pilot regulator 20. In addition, this operating pressure is applied to the surface on the air import port 34 side of the diaphragm 27, or in other words, on the surface opposite to the diaphragm 27 surface contacting the chemical liquid, and the valve body 24 is displaced in the axial line direction in response to the adjusted operating pressure. Note that the passage in the interior of the pilot regulator 20 for passing air from the air intake port 34 to the pressure operation chamber 33 is part of the gas passage passing gases between the first regulator and second regulator.

In the pilot regulator 20 thus configured, in the initial state where operating pressure is not activated in the pressure operation chamber 33, urging force of the compression coil spring 32 keeps the end of the wide diameter part 28 in contact with the valve seat 25, and the communication between the upstream valve chamber 23a and downstream valve chamber 23b is shut off. In this case, fluid flow from the intake part 21 to the discharge part 22 is obstructed. On the other hand, when air to the pressure operation chamber 33 is supplied, the valve body 24 resists the urging force of the compression coil spring 32 and displaces toward the other diaphragm 29, thus the upstream valve chamber 23a and downstream valve chamber 23b communicate with each other. Consequently, fluid flow from the intake part 21 and discharge part 22 is allowed. In addition, the distance between the end of the wide diameter part 28 and the valve seat 25 changes in response to the operating pressure in the pressure operation chamber 33. With this action, the fluid flow rate from the upstream valve chamber 23a to the downstream valve chamber 23b can be increased or decreased.

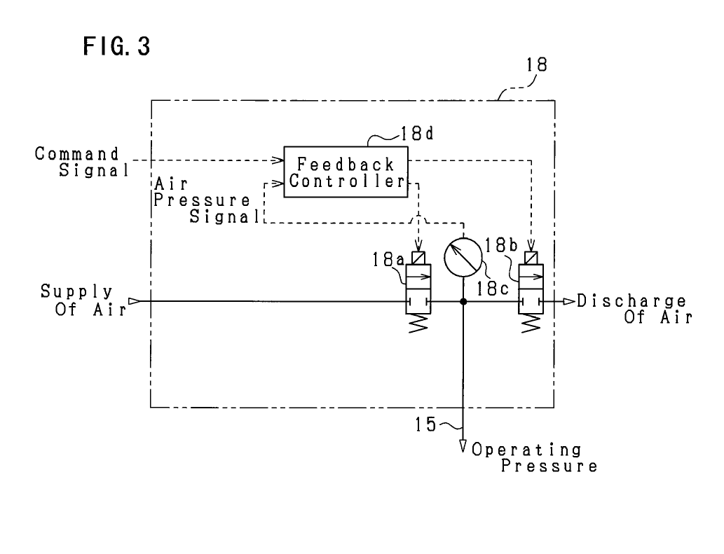

Next, the electropneumatic regulator 18 will be lined out based on FIG. 3. Note that FIG. 3 is a circuit diagram showing schematic view of the electropneumatic regulator.

The electropneumatic regulator 18 is connected to the pilot regulator 20 through the air passage 15, uses control of supply and discharge of air for the pilot regulator 20 to adjust the operating pressure for controlling the pilot regulator 20.

The electropneumatic regulator 18 comprises of an air-supply-side solenoid valve 18a on the air supply side, and a discharge-side solenoid valve 18b on the air discharge side. These solenoid valves 18a and 18b are opened and closed according to the state of energization to circulate or block the air. Note that these solenoid valves 18a and 18b are solenoid valves of the normally closed type, to block air when not energized.

The air-supply-side solenoid valve 18a and discharge-side solenoid valve 18b are connected by a passage, and this passage is connected to the air passage 15. Because of this, air supply and discharge for the air passage 15 is enabled. Note that the passage in the interior of the electropneumatic regulator 18 from the air passage 15 to each of the solenoid valves 18a and 18b is part of the gas passage passing gases between the first regulator and second regulator.

In addition, a pressure sensor 18c is installed in the passage connecting the air-supply-side solenoid valve 18a and discharge-side solenoid valve 18b, and this pressure sensor 18c detects air pressure inside the passage as operating pressure for control of the pilot regulator 20. The detected air pressure is output to a feedback controller 18d.

The feedback controller 18d is an electronic control device composed mainly of a microcomputer consisting of a CPU, various kinds of memory or the like. This controller 18d has command signals for operating pressure input from the main controller 30, and also has sequential input of air pressure detected by the pressure sensor 18c. This controller 18d drives the solenoid valves 18a and 18b based on each input, and implements feedback control to ensure that air pressure matches the command signals.

Specifically, the-air-supply-side solenoid valve 18a and discharge-side solenoid valve 18b are driven so that if one is open, the other one is closed, and changing the rate that each solenoid valve 18a or 18b in a standard period is used to control the air pressure. For example, if the air pressure is to be raised, the rate that the air-supply-side solenoid valve 18a is open during a standard period is increased, and the volume of air supplied to the air passage 15 through the air-supply-side solenoid valve 18a is increased, while the volume of air discharged from the air passage 15 through the discharge-side solenoid valve 18b is decreased. On the other hand, if the air pressure is to be lowered, the rate that the air-supply-side solenoid valve 18a is open during a standard period is decreased, and the volume of air supplied to the air passage 15 through the air-supply-side solenoid valve 18a is reduced, while the volume of air discharged from the air passage 15 through the discharge-side solenoid valve 18b is increased.

Here, when discharging air from the air passage 15 through the discharge-side solenoid valve 18b, gas constituents seeping through the diaphragm 27 of the pilot regulator 20 are contained in the gas, as described above. That would cause the discharge-side solenoid valve 18b and pressure sensor 18c a risk of corrosion due to these gas constituents. In addition, when air containing gas constituents exists in the air passage 15 in a relatively high pressure state, the solenoid valves 18a and 18b in the electropneumatic regulator 18 could well close and shut down. In this case, air containing the gas constituents comes into contact with the solenoid valves 18a, 18b and the pressure sensor 18c, therefore there is also a risk of corrosion for the air-supply-side solenoid valve 18a. Note that the electropneumatic regulator 18 and its component parts, particularly the discharge-side solenoid valve 18b, can consider formation using materials with resistance to corrosion to counter gas constituents derived from chemicals. Ordinarily, however, corrosion resistance in the magnetic materials used in solenoid valves is low, and use of materials with high corrosion resistance would unavoidably entail extremely high prices.

Therefore, in this embodiment, an orifice 40 as a restriction passage for discharging air from the air passage 15, and a check valve 50 for forcing air to flow only in the direction from the electropneumatic regulator 18 to the pilot regulator 20, are equipped, as shown in FIG. 1.

Specifically, a branch passage 41 is connected in the middle part of the air passage 15 connecting the pilot regulator 20 and electropneumatic regulator 18 and passing air. These passage connections can be performed by using conventional couplings. The branch passage 41 is formed with a narrower pipe than the air passage 15, and air flowing through the air passage 15 can be enabled to flow to the branch passage 41.

In the branch passage 41, an orifice 40 is equipped as a restriction passage with a predetermined microscopic flow passage area, and this orifice 40 is used to restrict the air flow rate. The orifice 40 is connected as a unit to the branch passage 41, and is formed to enable adjustment of the operating pressure by the electropneumatic regulator 18 while discharging air from the air passage 15. In other words, the orifice 40 flow passage area and flow passage length is designed so that discharging the air in minute quantities from the orifice 40 to the outside does not hinder adjustment of operating pressure by the electropneumatic regulator 18. Note that if the amount of air discharged from the orifice 40 is excessive, it can make raising the operating pressure difficult.

In addition, a check valve 50 is equipped in the air passage 15 between the electropneumatic regulator 18 and the orifice 40, or in other words, between the connector 42 for the air passage 15 and branch passage 41, and the electropneumatic regulator 18, to force air to flow only in the direction from the electropneumatic regulator 18 to the pilot regulator 20. This check valve 50 opens the flow passage only when the pressure on the electropneumatic regulator 18 side is higher than pressure on the pilot regulator 20 side, and is composed of a check ball, spring or the like. Moreover, this check valve 50 can be formed of materials with resistance to corrosion against gas constituents derived from chemical liquids. Note that the check valve 50 component parts and materials can be formed of anticorrosive materials, or the surfaces of the check valve 50 component parts and materials can be sheathed with anticorrosive materials.

According to the configuration in the present embodiment describe in detail above, the following superior effects will be obtained.

A pilot regulator 20 that applies operating pressure by using gas supplied to one surface of the diaphragm 27 provided in the regulator 20 and adjusts the flow rate of a fluid contacting the opposite surface, and an electropneumatic regulator 18 that controls supply and discharge of the gas for the pilot regulator 20 to adjust the operating pressure are equipped with the embodiment, thus the pilot regulator 20 can be used to adjust the chemical liquid flow rate based on operating pressure adjusted by the electropneumatic regulator 18.

Here, because the diaphragm 27 in the pilot regulator 20 contacts the chemical liquid targeted for flow rate adjustment, gas constituents derived from this chemical liquid can seep through the diaphragm 27. Moreover, this air and its gas constituents can pass through the air passage 15 that connects the pilot regulator 20 and electropneumatic regulator 18 and passes air for adjustment of the operating pressure to pass through the electropneumatic regulator 18, risking a situation where corrosion of the elecropneumatic regulator 18 component parts occurs.

On this point, the embodiment is provided with an orifice 40 that is connected to the air passage 15 and has a predetermined microscopic flow passage area, or in other words, the orifice 40 that enables adjustment of the operating pressure by the electropneumatic regulator 18 while discharging air from the air passage 15. This configuration enables adjustment of operating pressure by the electropneumatic regulator 18 while discharging the gas constituents from the orifice 40, to reduce the amount of gas constituents passing through the electropneumatic regulator 18. In addition, when air containing the gas constituents exists in the air passage 15 in a relatively high-pressure state, this air can be discharged from the orifice 40 even if the solenoid valves 18a and 18b in the electropneumatic regulator 18 have been closed and shut down, to reduce the amount of gas constituents contacting the electropneumatic regulator 18 component parts. As a result, corrosion in the electropneumatic regulator 18 adjusting operating pressure in the pilot regulator 20 can be suppressed.

Because a check valve 50 is equipped in the air passage 15 between the electropneumatic regulator 18 and the orifice 40, to force air to flow only in the direction from the electropneumatic regulator 18 to the pilot regulator 20, when raising the operating pressure, air can be forced to flow in the direction from the electropneumatic regulator 18 to the pilot regulator 20, and when lowering the operating pressure, air can be discharged from the orifice 40. As a result, only air not containing gas constituents passes through the electropneumatic regulator 18, and air containing gas constituents does not pass through the electropneumatic regulator 18. This will suppress further corrosion in the electropneumatic regulator 18.

Because the check valve 50 is formed from materials resistant to corrosion against gas constituents derived from the chemical liquid, operating instability due to corrosion in the check valve 50, which operates to stop the flow of air containing gas constituents in the direction of the electropneumatic regulator 18, can be suppressed.

The invention is not limited to the above embodiment. It could, for example, be implemented as follows.

In the above embodiment, the explanation included one example of using a flow rate control device for supplying chemical liquid to a semiconductor manufacturing line. But it could also be used for supply of other chemical liquids, or used for flow rate control of fluids other than chemical liquids. For example, it could be used on drug product manufacturing lines, or used on chemical product manufacturing lines, and the fluid targeted for flow rate control does not even need to be limited to liquids, as it could also be gases.

Corrosion of the orifice 40 due to gas constituents derived from chemical liquids can be suppressed if the orifice 40 is formed from materials with corrosion resistance to the gas constituents. In this case, changes in the flow rate of air flowing through the orifice 40 can be suppressed.

In the above embodiment, air was used as the gas used by the electropneumatic regulator 18 for adjusting the operating pressure. However, nitrogen and other gases can also be used. Here, if a gas that reduces the corrosiveness of gas constituents seeping through the diaphragm 27 is used, corrosion in the electropneumatic regulator 18 can be further suppressed.

In the above embodiment, an orifice 40 was equipped as a restriction passage with a predetermined microscopic flow passage area. However, if a variable-type restriction passage capable of changing the flow passage area is used as the restriction passage, then the flow passage area can be adjusted after assembly of the restriction passage, which would enable adjustment of the operating pressure by the electropneumatic regulator 18 while also setting the restriction passage to the optimum flow passage area for discharging air from the air passage 15. For example, a needle valve could be used for the variable-type restriction passage.

When a check valve 50 is equipped in the air passage 15 between the electropneumatic regulator 18 and the orifice 40, to force air to flow only in the direction from the electropneumatic regulator 18 to the pilot regulator 20, even if air can be discharged from the orifice 40 to lower the operating pressure, there is a risk that responsiveness will decline when the operating pressure is lowered.

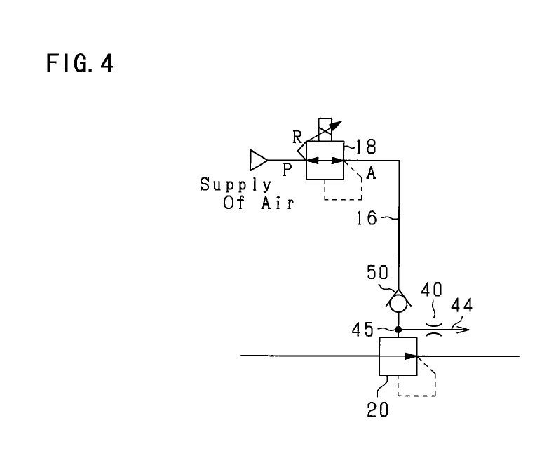

On this point, as shown in FIG. 4, installing the orifice 40 and check valve 50 in positions closer to the pilot regulator 20 than to the electropneumatic regulator 18 can reduce the volume of air discharged when the operating pressure is lowered. In other words, when operating pressure is lowered, in an air passage 16, the volume on the pilot regulator 20 side is more of a target for discharging air than the check valve 50, and in a branch passage 44, the volume of the connector 45 side is more of a target than the orifice 44. As a result, even if a check valve is equipped, the drop in responsiveness when the operating pressure is lowered can be suppressed.

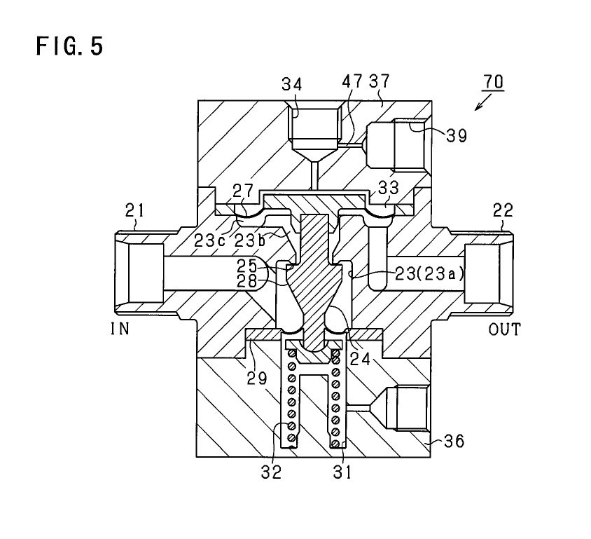

Furthermore, the gas passage passing air between the pilot regulator 20 and the electropneumatic regulator 18 is not limited to the air passage 15 connecting the pilot regulator 20 and the electropneumatic regulator 18. Internal passages forcing air flow inside these regulators 18 and 20 can also be used. In this case, as shown in FIG. 5, if for example an orifice 47 is formed at the first cover 37 in a pilot regulator 70, to discharge air from an air discharge port 39, the orifice 47 can be installed close to the diaphragm 27 of the pilot regulator 70, to reduce the volume of discharged air when the operating pressure is lowered. In addition, use of this kind of structure can ease manufacture, including for the pilot regulator 70, and can render unnecessary the excess space for installation of the orifice 47. In other words, because the orifice 47 is installed adjacent to the diaphragm 27 of the pilot regulator 20, the volume of air discharged when the operating pressure is lowered can be sharply reduced. Note that the orifice 47 can be assembled together with a check valve to the first cover 37 of the pilot regulator 70, or in other words, if a check valve is also installed adjacent to the diaphragm 27 of the pilot regulator 70, the volume of air discharged when the operating pressure is lowered can be further reduced.

In the above embodiment, a check valve 50 was equipped in the air passage 15. However, this check valve 50 can also be omitted. Even in such a case, adjustment of operating pressure by the electropneumatic regulator 18 while the gas constituents is discharged from the orifice 40 can still be performed to reduce the amount of gas constituents passing through the electropneumatic regulator 18. In addition, in cases where air containing the above gas constituents exists in the air passage 15 at a relatively high pressure state, the air can still be discharged from the orifice 40 even if the electropneumatic regulator 18 is closed and shut down, reducing the volume of gas constituents contacting the electropneumatic regulator 18.

In the above embodiment, a branch passage 41 is connected in the middle part of the air passage 15 connecting the pilot regulator 20 and electropneumatic regulator 18, and an orifice 40 with a predetermined microscopic flow passage area is equipped in the branch passage 41. However, a slit or microscopic hole discharging minute amounts of air can be formed in the air passage, for example, and other configurations can also be used. Note that if multiple restriction passages are used, the volume of gases discharged from the gas passages can be adjusted depending on the number of passages.

The first regulator adjusting the fluid flow rate is not limited to configurations like the pilot regulator 20 described in the above embodiment. Anything that applies operating pressure by using gas supplied to one surface of a diaphragm and adjusts the flow rate of a fluid contacting the opposite surface can be used. Note that even in configurations where gas is supplied to an area different from the one surface of the diaphragm to apply operating pressure, if the supplied gas flows between there and the one surface of the diaphragm, this invention can be applied to obtain effective results.

In addition, the second regulator adjusting the operating pressure of the first regulator is not limited to configurations like the electropneumatic regulator 18 described in the above embodiment. Anything that uses control of supply and discharging of gases for the first regulator to adjust the operating pressure of the first regulator can be used. In this kind of configuration, since gases containing gas constituents will pass through the second regulator in the course of the supply and discharge of gases for the first regulator, there is a risk of corrosion in the second regulator component parts.

1. A flow rate control device comprising:
a first regulator that applies operating pressure by using gas supplied to one surface of a diaphragm provided in the regulator, thereby adjusting the flow rate of a fluid contacting the opposite surface,
a second regulator that controls supply and discharge of the gas for the first regulator, to adjust the operating pressure,
a gas passage that passes the gas between the first regulator and second regulator, and
a restriction passage that enables adjustment of the operating pressure by the second regulator while discharging the gas from the restriction passage.

2. The flow rate control device in claim 1, wherein a check valve is installed in the gas passage, between the second regulator and the restriction passage, to force the gas to flow only in the direction from the second regulator to the first regulator.

3. The flow rate control device in claim 2, wherein the restriction passage and the check valve are installed in a position closer to the first regulator than to the second regulator.

4. The flow rate control device in claim 3, wherein the restriction passage is installed at the first regulator.

5. The flow rate control device in claim 4, wherein the check valve is installed at the first regulator.

6. The flow rate control device in claim 1, wherein the restriction passage has a flow passage area that is variable, and altering the flow passage area obtains the predetermined microscopic flow passage area.

7. The flow rate control device in claim 6, wherein a check valve is installed in the gas passage, between the second regulator and the restriction passage, to force the gas to flow only in the direction from the second regulator to the first regulator.

8. The flow rate control device in claim 7, wherein the restriction passage and the check valve are installed in a position closer to the first regulator than to the second regulator.

9. The flow rate control device in claim 8, wherein the restriction passage is installed at the first regulator.

10. The flow rate control device in claim 9, wherein the check valve is installed at the first regulator.

11. A flow rate control device comprising:
a first regulator that applies operating pressure by using gas supplied to one surface of a diaphragm provided in the regulator, thereby adjusting the flow rate of a fluid contacting the opposite surface,
a second regulator that controls supply and discharge of the gas for the first regulator, to adjust the operating pressure,
a gas passage that passes the gas between the first regulator and second regulator, and
a restriction passage connected to the gas passage with a predetermined microscopic flow passage area.

12. The flow rate control device in claim 11, wherein a check valve is installed in the gas passage, between the second regulator and the restriction passage, to force the gas to flow only in the direction from the second regulator to the first regulator.

13. The flow rate control device in claim 12, wherein the restriction passage and the check valve are installed in a position closer to the first regulator than to the second regulator.

14. The flow rate control device in claim 13, wherein the restriction passage is installed at the first regulator.

15. The flow rate control device in claim 14, wherein the check valve is installed at the first regulator.
